(19) United States
(12) Patent Application Publication
(10) Pub. No.: US 2002/0155289 A1
(43) Pub. Date: Oct. 24, 2002

(54) Melt processable perfluoropolymer forms

(76) Inventors: Frank Cistone, Newtown Square, PA (US); Jin Choi, Wilbraham, MA (US)

Correspondence Address: Fox, Rothschild, O'Brien & Frankel, LLP, Tenth Floor, 2000 Market Street, Philadelphia, PA, 19103, US

(21) Appl. No.: 10/087,212

(22) Filed: Feb. 28, 2002

(30) Foreign Application Priority Data
Sep. 1, 2000 (US) PCT/US00/23920

(51) Int. Cl. D03D 15/00; B32B 5/26; D01H 13/26; D02G 3/02; D04B 7/00; D02G 3/00; D04H 5/02

(52) U.S. Cl. 428/371; 442/181; 57/208; 57/246; 57/245; 442/192; 442/268; 442/199; 442/402; 428/369; 428/373; 442/403; 442/308

(57) ABSTRACT

Melt processable perfluoropolymer forms in woven, non-woven and knitted manifestations, and products produced therefrom such as filters and filtration support media are made of melt processable single and/or multicomponent yarns from a wide range of deniers, shapes and crimps.

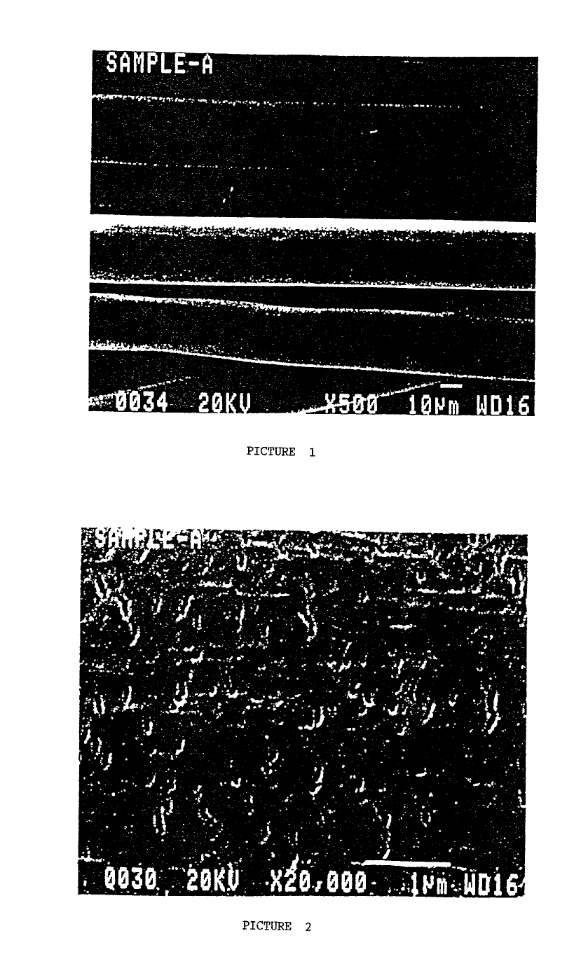

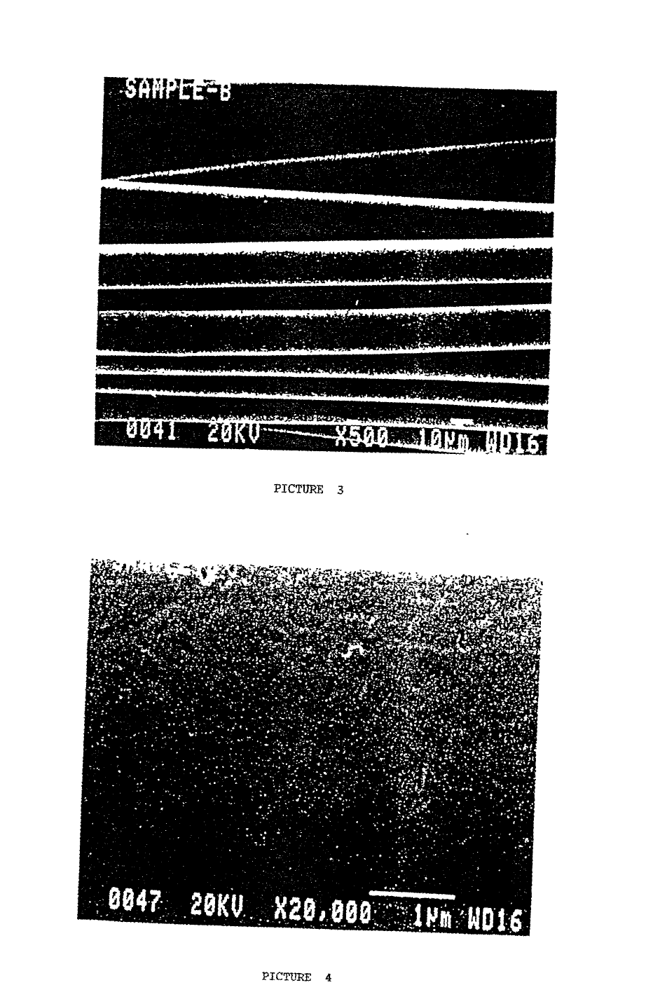

### BACKGROUND OF THE INVENTION

1. Field of the invention

The present invention relates to melt processable perfluoropolymer forms, such as woven, non-woven and knitted forms, and products prepared therefrom, such as filtration and filtration support media. More specifically, the melt processable perfluoropolymer forms of the present invention are prepared from melt processable perfluoropolymer fibers and yarns.

2. Description of the Prior Art

Perfluoropolymers are those polymers with all of their hydrogens substituted with fluorine, the best known of which is polytetrafluoroethylene or PTFE. These perfluoropolymers exhibit extreme chemical inertness to virtually all industrial chemicals, even at elevated temperatures. They also exhibit excellent temperature resistance at constant use temperatures of up to 300° C. They are also useful due to their low surface energy, which causes them to resist wetting and imparts anti-stick and anti-staining properties. In addition, perfluoropolymers are resistant to UV degradation, which makes them suitable for outdoor exposure as well as in applications where artificial UV light is used, such as in water purification.

The preparation of continuously extruded, melt spun, multifilament melt processable yarns and staple fibers prepared from melt processable perfluoropolymers are described by Vita et al. in U.S. Pat. Nos. 5,460,882; 5,552,219 and 5,618,481, all of which are incorporated in their entirety by reference. These fibers and yarns can be used to prepare various woven, non-woven and knitted forms. One type of process used to make non-woven product forms is felting, wherein staple fibers are formed into a web by a process known in the industry as carding, followed by needle punching in a continuous or batch mode. The non-woven felt produced by this method can be used as is or can incorporate a woven reinforcing scrim if so desired. A variety of other types of processes may be used on felts, such as calendering, hydro entangling, singeing and heat treating. The felts of the present invention encompass all types, including felts or fiber blends (e.g., glass, PTFE, etc.). Another type of process used for producing non-woven forms is wetlaid or paper making technology. Yet another standard process type is weaving, which is used to create woven forms (e.g., scrims and clothes) from yarns. Weaving processes may include a number of variants, such as the twisting of the yarn prior to weaving and then application of, for example, either a typical flat weave or a leno weave. Knitting machines, such as circular units, can be used to produce knitted fabrics. These and other types of processes and units used to produce forms are all applicable for use with the present invention.

The aforementioned forms can further be processed into filtration support media for use in either dry gas, wet filtration or coalescing apparatus and applications. In some of these applications it is known to use polytetrafluoroethylene (PTFE). For examples of these applications, see U.S. Pat. Nos. 3,986,851 to Rodek, 4,194,041 to Gore, et. al., 4,302,496 to Donovan, 4,361,619 to Forsten, et al., 4,612,237 to Frankenburg, 4,840,838 to Wyss, 4,877,433 to Oshitari, 4,902,423 to Bacino and 4,983,434 to Sassa, all of which are incorporated in their entirety by reference.

Product forms made from multifilament PTFE fibers have been used almost exclusively for these applications because PTFE fibers have been readily available and thought to have the best balance of properties. It has now been found, however, that product forms made from multifilament melt processable perfluoropolymer fibers have many advantages over those made from PTFE when used in the same or similar applications.

When compared with articles made from melt processable perfluoropolymer fibers and yarn, articles manufactured from PTFE fibers and yarns carry certain disadvantages which the present invention seeks to overcome. Recited below are eight problems associated with PTFE fibers and yarns; these problems are representative of some of the major disadvantages with PTFE fibers and yarns, and indicative of the great need in industry to find solutions to the problems and/or alternatives to PTFE fibers and yarns:

First, PTFE is not a melt processable perfluoropolymer. The fibers, yarns and subsequent forms derived from it often require special or extraordinary handling and do not lend themselves to typical processes used for manufacturing melt processable forms as do polyesters, nylons, etc. Those processes include, but are not limited to, calendering, potting, thermally fusing, and thermally laminating.

Second, PTFE fibers are not easily crimpable, and cannot accept a high level of crimp.

Third, PTFE fibers create forms which are not easily melt fused and have very poor laminating and potting capability. (Potting is a term given to the process of fusing a filter media into a cartridge filter end cap during the manufacturing process of that cartridge).

Fourth, PTFE fibers do not have smooth surfaces, which are a source of problems in the production of filtration media.

Fifth, yarns produced from PTFE by processes such as coextrusion spinning, slit film or slit expanded PTFE membrane processes, contain rough surfaces and diameter and tenacity variations, which are deleterious to their weavability properties.

Sixth, filtration media derived from PTFE fibers have relatively low levels of purity. Impurities introduced by PTFE need to be removed later and PTFE fibers are brown as a result of decomposed organic matter present in the fibers. The organic matter is necessary in the production of PTFE fibers to allow a processable “paste” to be made, which can then be formed into fiber structures. Although the fiber can be bleached for aesthetic reasons, the impurities left behind from the manufacturing process cannot be fully eliminated.

Seventh, PTFE webs are not easily pleated, which can be critical to many cartridge filter applications.

Lastly, in order to make PTFE or a modified PTFE (e.g. PTFE which contains a small amount of comonomer) usable for many applications (in part due to one or more of the above described problems) it is required to impose vigorous and strict processing conditions.

There exists, thus, a need to overcome these and other known problems in industry and to lessen and remove, if possible, the relatively onerous processing conditions required for PTFE and other perfluoropolymers and to create better webs, fabrics and other finished forms. The present invention seeks to eliminate these processing requirements and to create forms, and other products prepared therefrom, with improved properties. (It is understood that while fibers and yarns are sometimes discussed separately, the applications described for making inventive forms from one are generally applicable to the other.)

Accordingly, it is an object of the present invention to provide forms which have improved properties over prior art forms.

It is a further object of the present invention to provide melt processable perfluoropolymer forms.

It is yet another object of the present invention to provide relatively relaxed and efficient processing conditions to manufacture melt processable perfluoropolymer forms.

It is still another object of the present invention to provide melt processable perfluoropolymer forms which are easily and inexpensively prepared and maintained, and which have a longer service life than conventional forms.

It is also an object of the present invention to improve the appearance, properties and performance characteristics of melt processable perfluoropolymer forms.

This invention also relates to multilobal fibers having a variety of uses. More particularly, this invention relates to such fibers having at least about two lobes which are useful in such diverse applications as filtering, wicking, insulating and other applications.

It is yet still another object of the present invention to provide products derived from the inventive forms described herein.

It is still a further object of the present invention to provide filtration media with improved properties and performance characteristics.

These and other objects of the present invention can be appreciated by referring to the following description.

### SUMMARY OF THE INVENTION

The present invention provides melt processable perfluoropolymer forms, and products prepared therefrom, which are manufactured from melt processable perfluoropolymer fibers and yarns. Melt processable perfluoropolymer are preferably subjected to continuously extruded, melt spun, and/or multifilament processes to produce melt processable perfluoropolymer fibers and yarns (e.g. spinning techniques taught in the Vita et al patents discussed above and other similar processes). These melt processable perfluoropolymer fibers and yarns are then subjected to further processing to make a variety of melt processable perfluoropolymer forms, such as woven, non-woven and knitted forms. These melt processable perfluoropolymer form as can then be used via conventional techniques to make filtration support media.

A further understanding of the invention will be had by referring to the following description of preferred embodiments.

### DESCRIPTION OF PREFERRED EMBODIMENTS

The present invention contemplates the use of any melt processable perfluoropolymer, such as ones taught in the above discussed Vita et al patents, perfluoropolymers derived from tetrafluoroethylene (″TFE) and other fluorinated monomers, comonomers, termonomers, etc. Examples include MFA, PFA and FER. More specifically, a representative melt processable perfluoropolymer which can be utilized in the present invention is Hyflon® MFA 640 perfluoropolymer produced by Ausimont USA, Inc. in New Jersey. The MFA 640 perfluoropolymer is advantageously used to prepare fibers and yarns, which in turn can be felted, carded or needle punched in a continuous or batch mode. The non-woven felt produced by this method can be used as is or can incorporate a woven reinforcing scrim if so desired. This nonwoven form may also advantageously contain a blend of perfluoropolymer fibers with other fibers to impart desired properties to the felt. Wetlaid or paper making technology can be advantageously used to produce non-woven forms. Preferably, weaving the fibers and yarns will produce woven forms, such as scrims and cloth. The yarn is advantageously twisted prior to flat or leno weaving. Any normal type of weaving process, with or without a pretreatment of the fiber or yarn, can be used. Knitted fabrics can also be advantageously produced with, for example, a circular knitting machine.

A variety of weaving, knitting and non-woven techniques may be applied to convert the melt processable perfluoropolymer fibers and yarns to melt processable perfluoropolymer forms. Unlike the problems mentioned above with respect to PTFE, the fibers, yarns and forms according to the present invention do not require any special or extraordinary handling and are applicable to typical processes used for polyesters, polyolefins, nylons, etc., including calendering, potting, thermally fusing and thermally laminating.

While on a molecular level melt processable fibers are structurally similar to PTFE fibers, it has unexpectedly been found that the melt extruded perfluoropolymer fibers are, unlike PTFE, easily crimpable and able to accept a high level of crimp, similar to that found in conventional polyester, nylon and polyolefin fibers. These features are both desirable and necessary in order to use standard or normal industry carding and felting equipment.

Unlike PTFE fibers, forms derived from melt processable perfluoropolymer fibers and yarns are easily melt fused and give better laminating and potting capability. The use of melt processable perfluoropolymer fibers and yarns in the manufacture of bearing cloth yields physical property improvements, such as improved lubricity and improved durability over cloths made from PTFE yarn, expanded PTFE yarn or slit film yarns, as a result of the same continuous, uniform filament construction and residual elongation.

The melt processable perfluoropolymer forms can be used to prepare filtration and filtration support media. Melt processable perfluoropolymer yarns and fibers formed by the melt spinning process described in the above discussed Vita et al patents have a much smoother surface than PTFE yarns and fibers, due to their method of manufacture. Filtration media derived from melt processable perfluoropolymer fibers and yarns exhibit superior filtration properties. Improved properties include lower initial pressure drop, reduced tendency to foul leading to continued low pressure drop over filter life, easier cleaning and powder removal by back-pulsing, vibration, or other means to dislodge particulates, and improved coalescing due to more stable droplet formation.

The melt spinning process used to make melt processable perfluoropolymer fibers and yarns also allows for the production of multilobal fibers. Multilobal fiber forms advantageously increase the surface area of the individual fibers, leading to even further filtration efficiencies of these forms.

The continuous uniform nature of each filament in melt processable fluoropolymer fibers and yarns allows for improved weavability as compared to the rough surfaces of yarns produced from PTFF by any other process, including coextrusion spinning, slit film or slit expanded PTFE membrane processes. This continuity and uniformity, as well as the residual elongation typical of traditional melt spinning processes, also allow for improved physical property performance of filtration media, if subjected to typical flexing or pulsing stress in dry gas baghouse filter applications or in wet bag or cartridge filters. Filtration media manufactured from melt processable perfluoropolymer fibers and yarns will retain its physical integrity and strength over a longer period of time than filtration media manufactured from PTFE fibers and yarns.

Purity is another property of great concern to the filtration industry, especially in the semiconductor manufacturing area. Filtration media made from melt processable perfluoropolymer fibers and yarns have a higher level of purity than media derived from PTFE fibers and yarns, as a result of both the processes used to manufacture the fibers and yarns and processes used to manufacture the forms. In the manufacture of melt processable perfluoropolymer fibers and yarns, a traditional or normal melt spinning process is preferably applied to the melt processable perfluoropolymer. This type of process does not require the introduction of any impurities to the extrusion spinning process. In contrast, manufacturing PTFE fibers requires the addition of processing impurities, which if possible, need to be removed later.

Furthermore, wet laid webs or filter media can be thermally fused and therefore require no bonding agents to form a useful filter or filter support media. Moreover, another concern in industry is pleatability or the ability of a filter support of filtration media material to be folded by a typical pleating machine and retain that pleat. This is a critical feature in many cartridge filter applications. Melt processable perfluoropolymer fibers and yarns unexpectedly can be formed into wet laid, thermally fused materials, which can be much more easily pleated (and will retain that pleat) than PTFE fibers and yarns.

The ability to thermally bond and/or seal a nonwoven fabric is a very important and desirable characteristic. Specifically, in filtration applications, thermal bonding and sealing may be used to form complex shapes, such as filter bags. It may also be used to bond these fabrics to other assemblies, such as flow adapter fittings, mechanical seals, etc. The edges of a cut fabric may be heat scaled and sealed in order to reduce dusting and migration of staple fibers cut at that edge.

Bonding and sealing operations may be accomplished with heated air or metal dies; ultrasonic welding or other means may also be used to heat the part and melt the polymer. In any case, energy is applied to very localized areas of the part (at the scam) to partially melt the fabric. Alternative technologies include the use of chemical or polymeric adhesives, or simple mechanical means such as sewing. However, adhesives and other bonding agents are typically expensive, may be hazardous to apply, and often lack the chemical and environmental resistance and strength of the base fabric. In the case of fully fluorinated polymers, the surfaces typically require pre-treatment with aggressive solvents in order to permit adhesives to achieve sufficient bonds. Sewing and other mechanical means are also far from ideal, as the seam is intrinsically non-uniform, and can allow particles to pass through it which would not pass through the fabric itself.

The use of fibers made from melt-processable polymers in fabric manufacture permits the use of thermal sealing. As such, a uniform, strong bond or seal may be formed by partially melting the fabric at the bond point, while maintaining the purity and chemical/environmental resistance of the base fabric. The ability to bond and seal fabrics produced from melt-processable perfluoropolymer in this manner is a key advantage of these fabrics over those produced from non-melt-processable perfluoropolymers, such as PTFE. Uniform bonds may be achieved if the energy (heat, etc.) applied to the bond is held constant and the surfaces to be joined are aligned and compressed uniformly.

The present invention is further directed to multilobal fibers having unique properties. More particularly, the invention is directed to multilobal fibers formed from melt processable perfluoropolymers, wherein said fiber has a cross-section comprised of a central core having two or more shaped lobes projecting therefrom, i.e. the fibers of the invention may bilobal, trilobal, quadrilobal, pentalobal, etc.

The fiber of this invention can be manufactured using conventional fiber forming techniques. For example, the fiber can be formed by spinning a “fiber spinning composition” through a spinnerette having a configuration sufficient to provide a fiber having the desired cross-section. As used herein, a “fiber spinning composition” is a melt or solution of a polymer of fiber forming molecular weight. The nature of the spinning composition may vary widely. For example, the spinning composition may be a melt of a polymer or other material used in the formation of the fiber, and may be spun using conventional techniques as for example those melt spinning techniques described in Man Made Fibers Science and Technology Vol. 1-3, H. F. Mark et al., Interscience New York, 1968 and Encyclopedia of Polymer Science and Technology, Vol. 8. Similarly, the fiber spinning composition may be a solution of the polymer and other material used in the formation of the fiber which may be spun by using conventional solution spinning techniques, as for example those described in U.S. Pat. Nos. 2,967,085; 3,048,465; 4,413,110; 4,551,299 and 4,599,267.

The synthetic fibers of the present invention are generally prepared by melt spinning of the fiber forming polymer through a spinnerette. Various additives may be added to the respective polymer. These include, but are not limited to, lubricants, nucleating agents, antioxidants, ultraviolet light stabilizers, pigments, dyes, antistatic agents, soil resists, stain resists, antimicrobial agents, and flame retardants.

Typically, the polymer is fed into an extruder in form of chips or granules, indirectly melted and directed via jacketed Dowtherm RTM (Dow Chemical, Midland, Mich.) heated polymer distribution lines to the spinning head. The polymer melt may be metered by a high efficiency gear pump to spin pack assembly and extruded through a spinnerette with capillaries having least one multilobal opening, like tri-, tetra-, penta- or hexalobal capillary, preferably tri- and tetralobal capillary.

In another embodiment, the invention is also directed to conjugate multilobal spunbond fiber comprising at least two polymers where the fibers have lobes and each lobe has legs and caps, and the polymers are arranged with a first polymer occupying a portion of the fiber and at least one second polymer having a lower melting point than the first polymer occupying another portion of the fiber. Of course, one of the polymers is a melt processable perfluoropolymer.

As used herein the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side by side arrangement, a segmented configuration or an “islands-in-the-sea” arrangement. Conjugate fibers are taught in U.S. Pat. No. 5,108,820 to Kaneko ct al., U.S. Pat. Nos. 5,336,552 and 5,482,772 to Strack et al., and U.S. Pat. No. 5,382,400 to Pike et al., hereby incorporated by reference in their entirety. For two component fibers, the polymers may be present in ratios of 75/25, 50/50, 25/75 or any other desired ratios.

### EXAMPLE 1

A commercial sample of natural (unbleached) Teflon® PTFE multifilament yarn and a sample of multifilament yarn produced from Hyflon® MFA melt processable perfluoropolymer were observed by scanning electron microscope. The results are shown as pictures 1 through 4, The fibers in the PTFE yarn show imperfections and roughness which are approximately 10 microns in size (picture 1), and many fractures and fissures which are approximately 0.2 micron in size (picture 2). The melt processable MFA fibers are extremely smooth and regular, with no imperfections measuring 10 microns (picture 3), and have a dramatically reduced number of surface fissures measuring 0.2 microns in size compared with the PTFE.

### EXAMPLE 2

A beam for weaving was produced on a multi-end warping machine using 550 total denier, 109 filament yarn that had been pre-twisted with 3 turns per inch in the Z direction. The beam was placed on a Gem loom and a fabric was woven using a plain weave to yield a flat fabric 24 inches wide by 120 feet long with a mesh count of 64 ends per inch by 46 picks per inch. The selvedge was a leno selvedge (smooth edges, no fraying). Fabric weight was approximately 8.58 ounces per square yard. Filtration and mechanical characteristics are shown in Table 3. It was observed during the weaving process that the yarn was very consistent in diameter and tended to give better tension control than other low tenacity yarns (approximately 1 gram/denier) such as yarns made from PTFE fibers.

### EXAMPLE 3

A beam was produced on a single end warping machine using 575 total denier, 109 filament yarn that had been pre-twisted with 10 twists per inch in the Z direction. The beam was placed on a Gem loom and a fabric was woven using a leno weave to yield a fabric 42 inches wide by 21 feet long with 16 ends per inch by 16 picks per inch with a weight of approximately 3.4 ounces per square yard. Characteristics of the resulting scrim fabric are shown in table 1.

### EXAMPLE 4

550 total denier, 109 filament yarn produced from Hyflon® MFA melt processable perfluoropolymer was heated to 100′ C. on a heated godet. The heated yarn was fed continuously into a commercial 0.382 inch wide stuffer box with mechanical rolls at 200 meters per minute. The fiber was fed into the stuffer at a faster rate than it was taken away, creating a vertical stack of crimped fiber. The height of the stack was controlled by the takeaway speed and was adjusted to produce a yarn with a high level of texture or crimp, high bulk, and short crimp leg length.

### EXAMPLE 5

The yarn from example 4 was continuously fed into a commercial air entangler at 200 meters per minute. The entangler intermittently blows cold, compressed air streams through the fiber bundle to make nodes or points of entangled yarns where the individual filaments become nested. This is done to gather and lock the individual strands of parallel filaments, keeping them from opening in subsequent processing steps, making them easier to handle. The MFA yarn air entangled easily and with good inter-fiber entanglement at the nodes. The yarn was later knitted with good results. A hand held air splicer was also used and shown to be effective for splicing two separate pieces of MFA yarn together to form a uniform, strong, uninterrupted single continuous yarn.

### EXAMPLE 6

An 8,000 total denier Hyflon® MFA fiber tow, approximately 9 denier per filament, was heated to 100° C. on a heated godet and fed continuously at 100 meters per minute into the same stuffer box design described in example 4. The stack height was reduced to produce a higher amplitude crimp with a longer leg length in order to be more typical of staple fibers used for carding operations. Good quality crimp was produced, with approximately 20 crimps per inch. The crimped tow was then easily cut using a commercial radial blade tow cutter to achieve a fiber length of approximately 4.5 inches. The staple fiber produced was used in examples 13 through 19.

### EXAMPLE 7

A 12,000 total denier Hyflon® MFA fiber tow, approximately 5 denier per filament, was heated to 200° C. on a heated godet and fed continuously into the same stuffer box design and operating conditions described in Example 6. A more angular and resilient, improved quality crimp was produced under these conditions, with approximately 15 crimps per inch. The crimped tow was suitable for cutting on commercial radial blade tow cutters and was cut to approximately 3.5 inches in length.

### EXAMPLE 8

A 400 total denier Teflon® PTFE fiber tow, approximately 13.3 denier per filament, was heated to 150° C. on a heated godet and fed continuously into the same stuffer box design and conditions used in example 7, at 100 meters per minute. The tow exiting the crimping device had very low amount of crimp and most of the filaments were broken or damaged, reducing the strength of the tow dramatically, making it difficult to process further, Additionally, the broken filaments would make it impossible to make a consistent cut length required for staple fiber processes.

### EXAMPLE 9

Both 550 and 1000 total denier MFA yarns were knitted on a single end tubular jersey knitting machine using a weft knitting technique. Flat yarns, textured yarns and air entangled yarns were each used. All yarns knitted well.

### EXAMPLE 10

Three inch long, 5.5 denier per filament staple fibers produced from MFA melt processable perfluoropolymer were processed through a laboratory carding process and needle felt device. Good felts were produced; physical properties shown in table 2.

### EXAMPLE 11

Example 10 was repeated, except that one layer of 3.4 ounce per square yard MFA scrim, as described in example 3, was introduced between the carded batts during the needling process.

### EXAMPLE 12

A 50/50 blend of 4.5 denier and 9.0 denier staple fiber produced from MFA perfluoropolymer was pre-opened by standard practice and fed to a standard 18 inch laboratory-scale nonwovens card, producing a continuous carded web. The web was manually layered in the machine direction to yield batts of a target basis weight of 850 grams/meter squared. The web was needlepunched according to condition “A” (table 4). Carding and needling procedures typically used to process other synthetic fibers, such as polyester and polypropylene, were used. This process yielded a nonwoven fabric with excellent strength in the machine direction; physical properties are shown in table 3.

### EXAMPLE 13

Example 12 was repeated, except using 100% 5.0 denier fiber of example 7. The felt was later calendered as in example 17. The enhanced crimp and resilience of the fiber led to much improved fiber opening in carding, web uniformity, and overall carding performance. This was even more significant, because no 9.0 denier fiber was needed to be added to improve processing. The improved web quality and cohesion, obtained without the use of a coarse carrier fiber, led to needled felts of higher strength and uniformity, and improved filtration performance.

### EXAMPLE 14

Carded webs produced as in example 12 were manually layered such in the crossmachine direction, simulating a cross-lapped material. The web was needlepunched as in example 12. The resulting fabric possessed a good balance of strengths in the machine and cross-machine directions; results are shown in table 3.

### EXAMPLE 15

Web was produced as in Example 12 except that a woven scrim, as described in example 3, was placed in the middle of the parallel-layered webs. Needling was performed as in Example 12; results are in Table 3.

### EXAMPLE 16

The scrim of Example 3 was placed in the middle of webs cross-lapped as in Example 14, yielding a scrim-supported cross lapped product.

### EXAMPLE 17

The needled felt of Example 12 was densified using a heated calendering operation. The felt was continuously pre-heated and pressed between a set of nip rolls, at a temperature, of 190° C., yielding fabric with higher density, decreased air permeability, and reduced pore size. Fabric gauge was easily controlled by varying the gap between nip rolls, with minimal expansion after calendering. Nip roll gap was adjusted to obtain a fabric density (target) of 0.275 ounces/square inch.

### EXAMPLE 18

A felt produced as in Example 12 was thermally bonded to itself, using 325° C. hot air and pressure exerted by a small set of nip rolls. The resulting bond showed excellent strength, and demonstrated the ease and effectiveness of thermally sealing the fabric to produce leak-proof, unstitched seams, as well as thermally bonding to other surfaces. Products made from PTFE fibers cannot be thermally bonded to itself because it is not melt processable (does not flow under heat and pressure).

### EXAMPLE 19

A parallel, self-supported carded batt was produced as in Example 12, except with reduced needling according to condition “B” of Table 4. As shown in table 3, these results show the ability to control fabric density, air permeability, and pore size through needling conditions, without negatively affecting fabric strength.

TABLE 1

| | | Woven Scrim Properties: Example 3 | |
|---|---|---|---|
| Number of | Weight per Layer | Breaking Load | Mullen Burst Strength |
| Layers | oz/yd² | Pounds | psi |
| 1 | 3.4 | 29.7 | 45 |
| 2 | 3.4 | 63 | 76 |

TABLE 2

| | | Thickness | Weight | Air Permeability | Mullen Burst Strength |
|---|---|---|---|---|---|
| Example | Layers of Scrim | in | oz/yd² | ft³/min/ft² | psi |
| 10 | 0 | 0.075 | 19.44 | 49.5 | 85.5 |
| 11 | 1 | 0.074 | 26.78 | 73.6 | 88 |

TABLE 3

| | Weight | Thickness | Permeability @ 125 Pa | | Strength, kg | strength, kg |
|---|---|---|---|---|---|---|
| | gm² | mm | m^{3/}m²-min | lean Pore Size | MD | CMD |
| Example | STM D461 | STM D461 | ASTM D737 | Micron | cm strip/ASTM D1682 | |
| 2 | 306 | 0.26 | 2.3 | 30.3 | 38.1 | 27.7 |
| 12 | 885 | 2.67 | 18.4 | 30.5 | 35.8 | 17.5 |
| 14 | 631 | 2.00 | 33.8 | 40.0 | 16.3 | 18.3 |
| 15 | 1075 | 2.87 | 23.9 | 30.3 | 36.2 | 19.6 |
| 16 | 3 | 2.49 | 13.9 | 28.7 | 19.9 | 32.8 |
| 17 | 0 | 1.86 | 10.8 | 23.8 | 29.9 | 20.0 |
| 19 | 951 | 3.01 | 20.2 | 35.2 | 33.2 | 18.1 |

### SUBSTITUTE SHEET (RULE 26)

TABLE 4

| | | Needlepunch Conditions | |
|---|---|---|---|
| | | Frequency | Penetration Depth |
| Condition | Step | Penetrations/cm² | Mm |
| A | 1 | 121 | 5.9 |
| | 2 | 121 | 7.4 |
| | 3 | 121 | 10.0 |
| | 4 | 326 | 12.0 |
| B | 1 | 121 | 5.9 |
| | 2 | 121 | 7.4 |
| | 3 | 326 | 9.0 |

Although the present invention has been described with a certain degree of particularity, it is understood that the present invention has been made only by way of example and that numerous change in the details of construction and the combination and arrangement of parts may be resorted to without departing from the spirit and scope of the claims.

What is claimed is:

1. Textured yarns having from 1 to 100 crimps/inch derived from melt processable perfluoropolymers, having individual filament deniers from about 0.5 to about 300, and total yarn deniers of about 10 to 100,000, wherein said perfluoropolymer is selected from the group consisting of copolymers of tetrafluoroethylene with 1 to 5 mole % of at least one perfluoroalkoxylvinylether, where the alkyl group has from 1 to 4 carbon atoms, and copolymers of tetrafluoroethylene with 2 to 20 mole % of at least one perfluoroolefin having from 3 to 8 carbon atoms.

2. Staple fibers having from 1 to 50 crimps/inch derived from melt processable perfluoropolymers, having individual filament deniers from about 0.5 to about 300, and total yarn deniers of about 10 to 100,000, wherein said perfluoropolymer is selected from the group consisting of copolymers of tetrafluoroethylene with 1 to 5 mole % of at least one perfluoroalkoxylvinylether, where the alkyl group has from 1 to 4 carbon atoms, and copolymers of tetrafluoroethylene with 2 to 20 mole % of at least one perfluoroolefin having from 3 to 8 carbon atoms.

3. Single component and multicomponent yarns and staple fibers having from 1 to 100 crimps/inch derived from melt processable perfluoropolymers, having individual filament deniers from about 0.5 to about 300, and total yarn deniers of about 10 to 100,000 and having a cross-sectional shape selected from the group consisting of circular, elliptical, angular, hollow, multilobal, sheath core, or islands-in-the sea, and in the case of multicomponent fibers containing other melt processable polymers.

4. A yarn according to claim 3 having residual elongation of 1 to 50%, excellent filament uniformity, and low brittleness.

5. A high purity yarn and staple fiber according to claim 3 suitable for use in semiconductor, pharmaceutical, and other high purity applications.

6. A yarn according to claim 3 suitable for weaving, knitting, hydroentangling, flame treating, and other textile processes.

7. An air entangled yarn according to claim 3.

8. A twisted yarn, according to claim 3, having 1 to 20 twists per inch.

9. A woven fabric having a weight per square yard of from about 1 to about 100 ounces per square yard made from flat, air entangled, or twisted yarns according to claim 3, suitable for use in filtration, and as a support scrim in non-woven products.

10. A knitted fabric having a weight per square yard of from about 1 to about 100 ounces per square yard made from flat, air entangled, or twisted yarns according to claim 3, suitable for use in filtration, and as a support scrim in non-woven products.

11. A crimped staple fiber according to claim and 3, wherein the filaments have been crimped to give an angular saw toothed shape having from 1 to 50 crimps per inch, cut to any length, suitable for use on standard carding equipment to make nonwoven batts which can then be needled into felts, for carding into sliver for making spun yarns, or for producing high loft air laid non-woven products.

12. A non-woven perfluoropolymer fabric having a weight per square yard of from about 1 to about 100 ounces per square yard produced by needlepunching of a continuous, carded staple fiber web, made from staple fibers according to claim 11, having excellent strength in both the machine and cross-machine directions, and good filtration properties.

13. A lightly needled or un-needled carded batt made from melt processable perfluoropolymer fiber according to claim 11, which has been densified and/or bonded through a heated calendering process, with smooth, textured, or patterned calender rolls, to yield a fabric with increased strength and stiffness as compared to its precursor.

14. A fabric, according to claim 12, further including a perfluoropolymer woven supporting fabric or scrim for increased strength.

15. A fabric, according to claim 12, further including a woven supporting fabric or scrim made from materials selected from the group consisting of glass, aramid, polyacrylate, polyphenylene sulfide, polyimide, polyester, polyamide, partially fluorinated polymers, carbon, or other natural or synthetic fibers for increased strength.

16. A fabric according to claims 12, 14 and 15 where the fabric density, air permeability, and mean pore size can be controlled through needling conditions.

17. A calendered fabric according to claims 12, 14 or 15 where the fabric density, air permeability, and mean pore size can be controlled through the heated calendering/densification process with smooth, textured, or patterned calender rolls.

18. A fabric according to claim 12 or 13, made from a blend comprising: from 1 to 99 percent melt processable perfluoropolymer staple fibers; and 99 to 1 percent fibers selected from the group consisting of glass, aramid, polyacrylate, polyphenylene sulfide, polyimide, polyester, polyamide, partially fluorinated polymers, carbon, or other synthetic fibers, the fabric being made either with or without a woven support scrim made from either a perfluoropolymer or from materials selected from the group consisting of glass, aramid, polyacrylate polyphenylene sulfide, polyimide, polyester, polyamide, partially fluorinated polymers, carbon, or other natural or synthetic fibers, the scrim being added for increased strength, and where the fabric density, air permeability and mean pore size can be controlled through needling conditions and through the heated calendaring/densification process with smooth, textured, or patterned calender rolls.

19. A fabric according to claims 12 or 13 made from a blend comprising: 1 to 99 percent melt processable perfluoropolymer staple fibers; and 99 to 1 percent PTFE fibers, the fabric being made either with or without a woven support scrim made from either a perfluoropolymer or from materials selected from the group consisting of glass, aramid, polyacrylate polyphenylene sulfide, polyimide, polyester, polyamide, partially fluorinated polymers, carbon, or other natural or synthetic fibers, the scrim being added for increased strength and where the fabric density, air permeability and mean pore size can be controlled through needling conditions and through the heated calendaring/densification process with smooth, textured, or patterned calender rolls.

20. Flat, air entangled and twisted yarns, staple fibers, and woven, knit and nonwoven fabrics made with or without woven support scrims, derived from melt processable perfluoropolymers, which are thermally bonded to themselves.

21. Flat, air entangled and twisted yarns, staple fibers, and woven, knit and nonwoven fabrics made with or without woven support scrims, derived from melt processable perfluoropolymers, thermally bonded to other high temperature plastics, fabrics and other media.

22. Filtration and coalescing media, support layers, drainage layers, and other components produced by winding continuous or spun flat, air entangled, or textured yarns derived from melt processable perfluoropolymers, with purity sufficient for industrial chemical, pharmaceutical, and semiconductor applications, where fibers may be bonded to themselves or to other high temperature plastics, fabrics, or other media.

23. Filtration and coalescing media, support layers, drainage layers, and other components produced from w oven, knit and nonwoven fabrics made with or without woven support scrims, derived from melt processable perfluoropolymer yarns and fibers, with purity sufficient for industrial chemical, pharmaceutical, and semiconductor applications, where fibers may be bonded to themselves or to other high temperature plastics, fabrics, or other media.

24. Filtration and coalescing components according to claim 22 or 23 with seams formed by thermal fusion.

25. Filtration and coalescing components according to claim 22 or 23 which are melt fused to other components of the filter or the filter housing to form a liquid tight seal.

26. Filtration and coalescing components according to claim 22 or 23 having less tendency to foul and easier cleaning by back-pulsing, rinsing, mechanical means, or other techniques.

27. Pleatable filtration and coalescing components according to claim 22 or 23.

28. Filtration and coalescing components according to claim 22 or 23 thermally bonded to other media, such as membranes, drainage layers, pleat supports and any other component of filter elements or devices.

29. A self-supported or scrim supported needlefelt derived from melt processable perfluoropolymer fibers according to claim 11, possessing a Mullen burst strength (ASTM-D3776) between 50 and 400 psi.

30. A self-supported or scrim-supported needlefelt derived from melt processable perfluoropolymer fibers according to claim 11, possessing an air permeability between 1 and 300 cfm/ft² at 0.5″ water pressure.

31. A woven fabric having a weight per square yard of about 1 to about 100 ounces per square yard, made from a blend comprising: 1 to 99 percent by weight flat, air entangled, or textured yarns derived from melt processable perfluoropolymer; and 99 to 1 percent of fibers or yarns made from materials selected from the group consisting of glass, aramid, polyacrylate, polyphenylene sulfide, polyimide, polyester, polyamide, partially fluorinated polymers, carbon, or other natural or other synthetic fibers, suitable for use in filtration, and as a support scrim in nonwoven products.

32. A woven fabric having a weight per square yard of about 1 to about 100 ounces per square yard, made from a blend comprising: 1 to 99 percent by weight flat, air entangled, or textured yarns derived from melt process able perfluoropolymer; and 99 to 1 percent by weight of fibers or yarns made from polytetrafluoroethylene (PTFE), suitable for use in filtration, and as a support scrim in nonwoven products.

33. A knitted fabric having a weight per square yard of about 1 to about 100 ounces per square yard, made from a blend comprising: 1 to 99 percent by weight flat, air entangled, or textured yarns derived from melt processable perfluoropolymer; and 99 to 1 percent of fibers or yarns made from material selected from the group consisting of glass, aramid, polyacrylate, polyphenylene sulfide, polyimide, polyester, polyamide, partially fluorinated polymers, carbon, or other natural or other synthetic fibers, suitable for use in filtration, and as a support scrim in nonwoven products.

34. A knitted fabric having a weight per square yard of about 1 to about 100 ounces per square yard, made from a blend comprising: 1 to 99 percent by weight flat, air entangled, or textured yarns derived from melt processable perfluoropolymer; and 99 to 1 percent by weight of fibers or yarns made from polytetrafluoroethylene (PTFE), suitable for use in filtration, and as a support scrim in nonwoven products.

35. Flat, air entangled, and twisted yarns, staple fibers, and woven, knit, and nonwoven fabrics made with or without woven support scrims, derived from a blend comprising: 1 to 99 percent by melt processable perfluoropolymer fibers or yarns; and 99 to 1 percent of fibers or yarns made from materials selected from the group consisting of glass, aramid, polyacrylate, polyphenylene sulfide, polyimide, polyester, polyamide, partially fluorinated polymers, carbon, or other natural or other synthetic fibers, which are thermally bonded to themselves.

36. Flat, air entangled, and twisted yarns, staple fibers, and woven, knit, and nonwoven fabrics made with or without woven support scrims, derived from a blend comprising: 1 to 99 percent by melt processable perfluoropolymer fibers or yarns; and 99 to 1 percent of fibers or yarns made from polytetrafluoroethylene (PTFE), which are thermally bonded to themselves.

37. Flat, air entangled, and twisted yarns, staple fibers, and woven, knit, and nonwoven fabrics made with or without woven support scrims, derived from a blend comprising: 1 to 99 percent by melt processable perfluoropolymer fibers or yarns; and 99 to 1 percent of fibers or yarns made from materials selected from the group consisting of glass, aramid, polyacrylate, polyphenylene sulfide, polyimide, polyester, polyamide, partially fluorinated polymers, carbon, or other natural or other synthetic fibers, which are thermally bonded to other high temperature plastics, fabrics and other media.

38. Flat, air entangled, and twisted yarns, staple fibers, and woven, knit, and nonwoven fabrics made with or without woven support scrims, derived from a blend comprising: 1 to 99 percent by melt processable perfluoropolymer fibers or yarns; and 99 to 1 percent of fibers or yarns made from polytetrafluoroethylene (PTFE), which are thermally bonded to other high temperature plastics, fabrics and other media.

39. Filtration and coalescing media, support layers, drainage layers, and other components produced by winding continuous or spun yarns, made from a blend comprising: 1 to 99 percent melt processable perfluoropolymer yarns or fibers; and 99 to 1 percent by weight of fibers or yarns made from materials selected from the group consisting of glass, aramid, polyacrylate, polyphenylene sulfide, polyimide, polyester, polyamide, partially fluorinated polymers, carbon, or other natural or other synthetic fibers.

40. Filtration and coalescing media, support layers, drainage layers, and other components produced by winding continuous or spun yarns, made from a blend comprising: from 1 to 99 percent melt processable perfluoropolymer yarns or fibers; and 99 to 1 percent PTFE yarns or fibers.

41. Filtration and coalescing media, support layers, drainage layers, and other components produced from woven, knit and nonwoven fabrics made with or without woven support scrims, made from a blend comprising: from 1 to 99 percent melt processable perfluoropolymer yarns or fibers; and 99 to 1 percent by weight of fibers or yarns made from materials selected from the group consisting of glass, aramid, polyacrylate, polyphenylene sulfide, polyimide, polyester, polyamide, partially fluorinated polymers, carbon, or other natural or other synthetic fibers, where the fibers and forms many or may not be thermally bonded to themselves or other components in the filter assembly, with purity suitable for the industrial chemical, pharmaceutical, and semiconductor industries.

42. Filtration and coalescing media, support layers, drainage layers, and other components produced from woven, knit and nonwoven fabrics made with or without woven support scrims, made from a blend comprising: from 1 to 99 percent melt processable perfluoropolymer yarns or fibers; and 99 to 1 percent PTFE yarns or fibers, where the fibers and forms many or may not be thermally bonded to themselves or other components in the filter assembly, with purity suitable for the industrial chemical, pharmaceutical, and semiconductor industries.

43. Filtration and coalescing components according to claim 39, 40, 41 or 42 with seams formed by thermal fusion.

44. Filtration and coalescing components according to claim 39, 40, 41 or 42 which are melt fused to other components of the filter or the filter housing to form a liquid tight seal.

45. Filtration and coalescing components according to claim 39, 40, 41, or 42 having less tendency to foul and easier cleaning by back-pulsing, rinsing, mechanical means, or other techniques.

46. Pleatable filtration and coalescing components according to claim 39, 40, 41 or 42.

47. Filtration and coalescing components according to claim 39, 40, 41 or 42 thermally bonded to other media, such as membranes, drainage layers, pleat supports and any other component of filter elements or devices.

48. A self-supported or scrim supported needlefelt made from a blend comprising: from 1 to 99 percent melt processable perfluoropolymer fibers according to claim 11; and 99 to 1 percent fibers made from materials selected from the group consisting of glass, aramid, polyacrylate, polyphenylene sulfide, polyimide, polyester, polyamide, partially fluorinated polymers, carbon, or other natural or other synthetic fibers, said needlefelt possessing a Mullen burst strength (ASTM-D3776) between 50 and 400 psi.

49. A self-supported or scrim supported needlefelt made from a blend comprising: from 1 to 99 percent melt processable perfluoropolymer fibers according to claim 11; and from 99 to 1 percent PTFE fibers, said needlefelt possessing a Mullen burst strength (ASTM-D3776) between 50 and 400 psi.

50. A self-supported or scrim supported needlefelt made from a blend comprising: from 1 to 99 percent by weight of melt processable perfluoropolymer fibers according to claim 11; and 99 to 1 percent by weight fibers made from materials selected from the group consisting of glass, aramid, polyacrylate, polyphenylene sulfide, polyimide, polyester, polyamide, partially fluorinated polymers, carbon, or other natural or other synthetic fibers, said self supported or scrim supported needlefelt possessing an air permeability between 1 and 300 cfm/ft² at 0.5″ water pressure.

51. A self-supported or scrim supported needlefelt made from a blend comprising: from 1 to 99 percent by weight of melt processable perfluoropolymer fibers according to claim 11; and 99 to 1 percent PTFE fibers, said self-supported or scrim supported needlefelt possessing an air permeability between 1 and 300 cfm/ft² at 0.5″ water pressure.

52. Filtration and coalescing components containing melt processable perfluoropolymer fibers, either alone, blended with other fibers or mixed with other materials, with seams formed by sewing, use of an adhesive, or by mechanical fasteners.

53. Filtration and coalescing components containing melt processable per fluoropolymer fibers, either alone, blended with other fibers or mixed with other materials, which are attached to other components of the filter or the filter housing, using an adhesive, to form a liquid tight seal.

54. Filtration and coalescing components containing melt processable perfluoropolymer fibers, either alone, blended with other fibers or mixed with other materials, attached to other media, such as membranes, drainage layers, pleat supports and any other component of filter element devices using an adhesive, by sewing, or by mechanical fasteners.
